(19) United States
(12) Patent Application Publication
(10) Pub. No.: US 2026/0167165 A1
(43) Pub. Date: Jun. 18, 2026

(54) BRAKE DEVICE WITH AN ELASTIC PROTECTION DEVICE AND METHOD FOR MOUNTING A PROTECTION DEVICE

(71) Applicant: Continental Automotive Technologies GmbH, Hannover (DE)

(72) Inventors: Thomas Sellinger, Dreieich (DE); Kevin Kiwus, Frankfurt am Main (DE)

(73) Assignee: Continental Automotive Technologies GmbH, Hannover (DE)

(21) Appl. No.: 18/712,058

(22) PCT Filed: Oct. 17, 2022
(86) PCT No.: PCT/DE2022/200237

§ 371 Date: May 21, 2024

(30) Foreign Application Priority Data
Nov. 23, 2021 (DE) 10 2021 213 186.7

(51) Int. Cl. B60T 11/16; F16J 3/04

(52) U.S. Cl. CPC B60T 11/165; F16J 3/04

(57) ABSTRACT

A brake unit for a motor vehicle brake system, comprises at least one brake unit housing and at least one elastic protective device fastened to the brake unit housing, which is arranged as a barrier against dirt, in particular against dust, wherein the protective device has at least one axially compressible bellows portion with a plurality of outer folds and inner folds connected by flanks and alternately arranged in the axial direction. In order to realize an automatable assembly, it is proposed that the protective device has at least one integrated support means for the defined reduction of an axial compression dimension of the bellows region. In a further aspect, a method for mounting the protective device on the brake unit housing is described.

### TECHNICAL FIELD

The embodiments relate to a brake unit for a hydraulic motor vehicle brake system.

### BACKGROUND

Most motor vehicle brake units are operated by an actuating member, in particular a piston rod, which dips into the brake unit and is coupled to a piston therein. An interface of this type has to be carefully isolated from the environment to prevent dirt, moisture or dust from being deposited in it or entering the brake unit and impairing its operation. Because actuating members such as piston rods are not only moved in a purely translational manner when actuated, but are also easily swiveled at the same time, sliding seals are not suitable for sealing such interfaces. In addition, such sealing elements place particularly high demands on the surface quality of the actuating member.

In practice, it has therefore become established to use hose-like axially compressible elastic protective devices, which are fastened with one end to the brake unit housing and with another end to the actuating member. In order for such a protective device to have sufficient flexibility, it is known to provide this with a bellows portion.

For a generic brake unit, reference is made to WO 2018/054619 A1, for example.

However, the installation of such thin-walled elastic protective devices poses a challenge due to their flexibility. When applying an axially directed force during installation of the protective device, its deformation behavior is significantly influenced by even the smallest deviations of the initial configuration (angle, dimensional accuracy, coefficient of friction, etc.) and is therefore hardly predictable. Such behavior is contrary to desirable automation capability. This must therefore be done manually to ensure proper assembly. However, a manual operation or manual work step requires a lot of time, requires additional control measures to avoid the variation in results and therefore requires comparatively high assembly costs.

The task is thus to propose a solution to improve the assembly capability of a protective device of the generic type and, in particular, to be able to implement an assembly which can be automated.

### SUMMARY

The embodiments provide that at least one support is integrated into the protective device, which selectively reduces the axial compression of the bellows region and limits it to a defined dimension. Thus, the protective device is stabilized at a defined degree of compression and it becomes possible by way of the support means to transfer the assembly force by the protective device from one to the other of its axial ends. The deformation behavior of the protective device becomes predictable.

Further measures below describe the design of the interface to the brake unit housing and the implementation an automatic fixation capability.

This enables automatable mounting of the protective device, which in turn enables an equivalent, reproducible execution capability of the assembly step in series production of the brake unit with an increased cyclical frequency. Control measures can thus be reduced without loss of safety and manufacturing costs reduced.

### DESCRIPTION OF THE DRAWINGS

Further features will emerge from the following description of one exemplary embodiment. In the following:

FIG. 1 shows a brake unit of the generic type with a known protective device.

FIG. 2 shows one embodiment of an improved protective device in the mounted unactuated state in axial section.

FIG. 3 shows a cross section through the outer fold of the protective device according to FIG. 2.

FIG. 4 shows an enlarged view of a fold of the bellows portion in a relaxed (a) and an axially compressed (b) state.

FIG. 5 shows a protective device during mounting with an assembly tool.

FIG. 6 shows an enlarged representation of the interface between the protective device and the brake unit housing in axial section.

FIG. 7 shows a view of reinforcing ribs of the fastening portion of the protective device in a three-dimensional exterior view.

### DETAILED DESCRIPTION

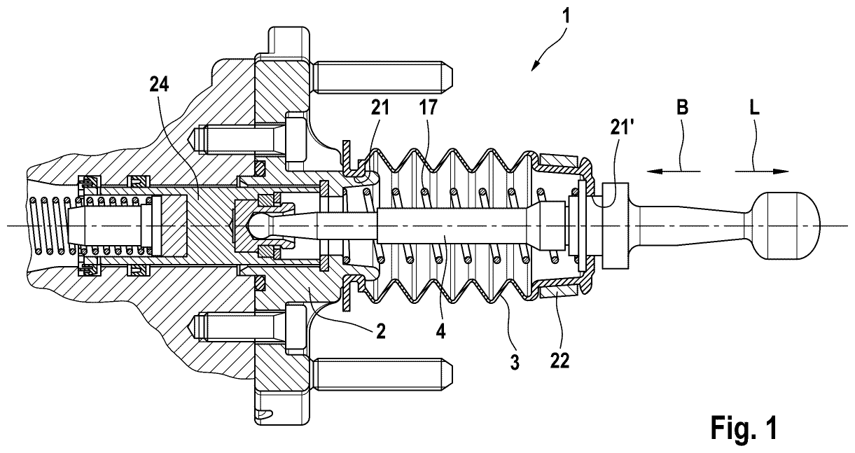

FIG. 1 illustrates a known brake unit 1 of the generic type shown by way of example has a brake unit housing 2 with a piston 24 arranged therein, which can be operated by an actuating member 4 in the actuating direction B. The actuating member 4 for its part can be actuated, for example, by a brake pedal (coupled to it, not shown here) or an actuator. A helical spring 17 is clamped between the brake unit housing 2 and the actuating member 4, which helical spring 17 acts as a return spring and resets the actuating member 4 together with the piston 24 after completion of a braking operation into their original unactuated starting position in the release direction L.

A thin-walled protective device 3 fastened to the brake unit housing 2 is made of an elastic material and envelops a portion of the actuating member 4 together with the helical spring 17 and serves as a barrier against dirt particles in the vicinity of the brake unit 1. This prevents, for example, dirt and dust from penetrating the interface between the actuating member 4 and the brake unit 1 or directly into the brake unit 1 and impairing its function.

The protective device 3 must be axially compressible upon actuation of the actuating member 4 and has a bellows portion 5 for this purpose.

The known protective device 3 shown here is snapped at both ends into substantially rectangularly configured radial grooves 21, 21′ with respectively correspondingly shaped end profiles and thereby axially fixed in a positively locking manner. In order to prevent the protective device 3 from slipping from the actuating member 4 during operation of the brake unit 1, this is additionally equipped with a radially externally inserted reinforcing ring 22. The installation of such a protective device 3 on the brake unit 1 can only be done manually.

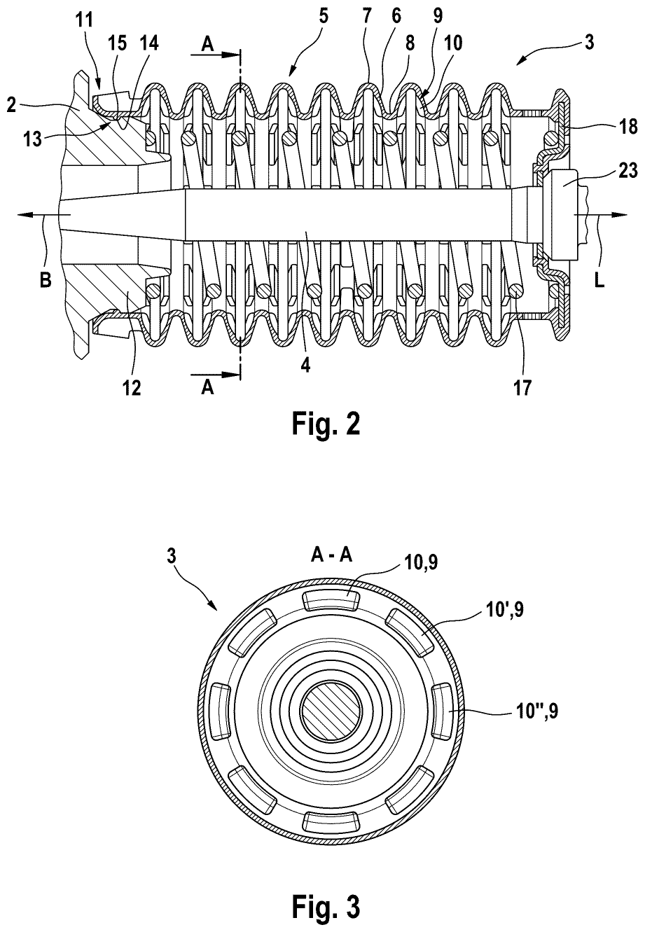

FIG. 2 shows one embodiment of an improved protective device 3 in an assembled state in axial section.

The protective device 3 is produced in a substantially thin-walled manner from an elastic material, preferably an elastomer such as EPDM, for example.

The bellows portion 5 has a plurality of outer folds 7, in each case alternately arranged in the axial direction, and inner folds 8, which are formed as round folds. It is irrelevant here whether the rounding radius is constant or variable. The outer folds 7 and inner folds 8 are connected by flanks 6 which are substantially straight in cross section.

Solid axial projections 10 or thickened portions are formed on the inside of the flanks 6. The totality of all axial projections forms a support means 9, which specifically shortens the stroke or the axial degree of compression of the bellows portion 5 to a desired dimension.

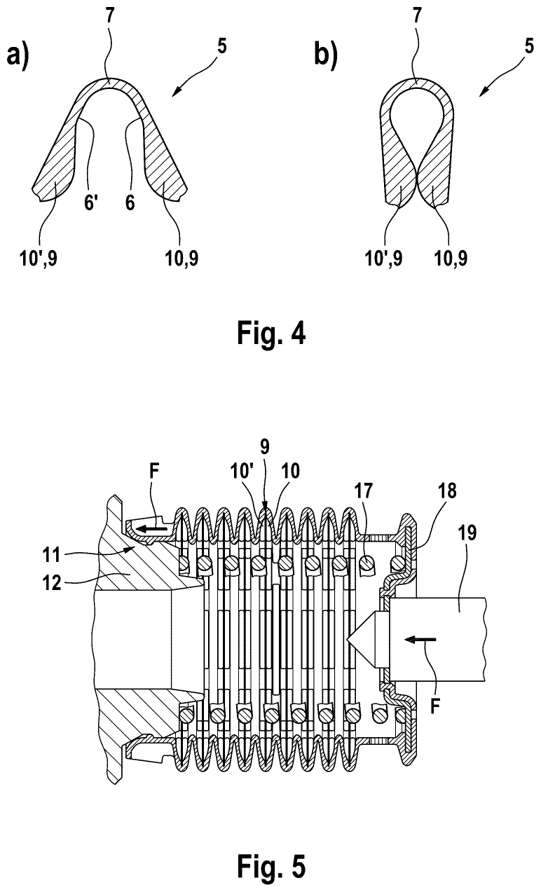

The mode of action of the support means 9 is explained in more detail below, in particular in FIG. 4.

The support means 9 can be formed, instead of as shown on the inside, also on the outside of the bellows portion 5. However, the outside is more susceptible to dirt deposits, which may tend to impair correct functioning of the support means 9.

At its end facing the brake unit housing 2, a fastening portion 11 is formed on the protective device 3, by way of which fastening portion 11 the protective device 3 is fixed to a corresponding fastening stub 12 of the brake unit housing 2 with the formation of an axial undercut 13.

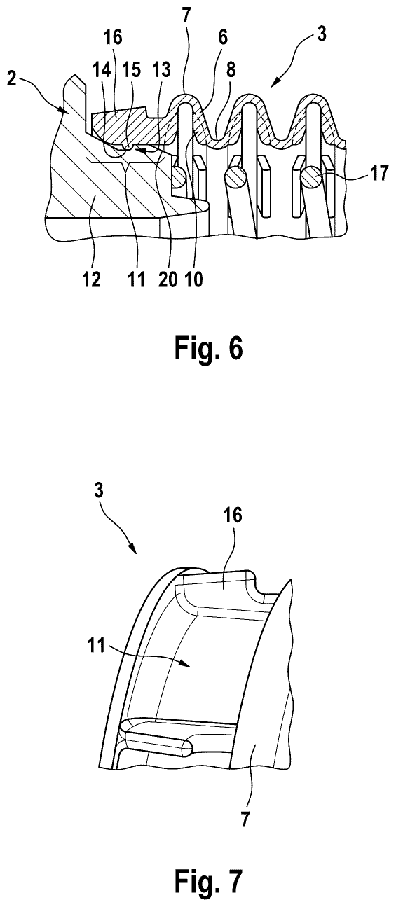

The mode of action of the fastening portion 11 is explained in more detail below, in particular in FIG. 6.

On its opposite end of the protective device 3 to the brake unit housing 2, a separate supporting disk 18 is attached. The supporting disk 18 is made of a stable material, for example steel sheet or a fiber-reinforced plastic, and serves firstly as a spring cup or abutment for the internal return spring 12. In this case, the supporting disk 18 is supported in the release direction L on a stop 23 on the actuating member 4. For a permanently stable connection, the supporting disk 18 may be overmolded in a positively locking manner at least in sections with the elastic material of the protective device 3 or embedded in it.

FIG. 3 shows the bellows portion 5 according to FIG. 2 in a cross section through the outer fold 7. The support means 9 is designed here in the form of several block-like axial projections 10, 10′, 10″, . . . formed on the inside of the flank 6 such that they are spaced apart from one another in the circumferential direction in a segment-like manner.

In further embodiments which are not shown here, the support means 9 can be configured, instead of as described above, with a large number of short block-like axial projections in a small segmented manner, can have only a few axial projections of bead-like extended design in the circumferential direction, or a single axial projection 10 can be shaped as a circumferential bead.

FIG. 4 shows the bellows portion 5 in cross section in the area of a single fold in an unactuated starting position according to FIG. 2 (view a) and a compressed position according to FIG. 5 (view b).

Axial projections 10, 10′ are formed opposite to each other on sides of adjacent flanks 6, 6′ which are directed toward one another. When compressing the bellows portion 5, an end of the protective device 3 is loaded with an input force. Here, the fold 7 bends until the axial projections 10, 10′ collide. This prevents further axial compression of the bellows portion 5, and the input force is transmitted to the other end via the wall of the protective device 3. The wall in the area of the fold remains thin and flexible in the process.

Compared to a simple general increase in the wall thickness of the protective device 3, the bellows portion 5 generates a low resistance during regular actuation. Further, the durability of the protective device 3 is improved, because, if the wall thickness is increased in the area of a fold 7, 8, the material would be subjected to much greater stress on elongation and crushing during bending, which could lead to a long-term crack formation and functional failure.

FIG. 5 shows an automatable assembly process of the protective device 3 on the brake unit housing 2 by means of a separate assembly tool 19.

For this purpose, the helical spring 17 is pushed into the protective device 3 and the protective device 3 is positioned with its fastening portion 11 on the fastening stub of the brake unit housing 2, with the result that the helical spring 17 is likewise positioned on its brake unit housing-side seat. An assembly tool 19 is applied to the opposite end of the protective device 3. For this purpose, a tool tip, conically formed in a manner which is optimized in terms of self-centering, of the assembly tool 19 is inserted into the central opening of the supporting disk 18, which is engaged through in operation by the actuating member 4.

The assembly tool 19 is then pushed linearly in the direction of the brake unit housing 2 with an assembly force F. The assembly force F is first introduced into the helical spring 17 via the supporting disk 18, with the result that these are compressed together with the bellows portion 5. After a defined distance, the support means 9 is activated by the individual axial projections 10, 10′ colliding with each other and thereby preventing further axial compression of the bellows portion 5. The assembly force F is then introduced into the wall of the protective device 3 and the support means 9 and transferred to the fastening portion 11, which is thereby pushed over the fastening stub 12 and latches onto it.

In order to simplify the explanation, a loss of force of the assembly force F resulting in reality from compression of the helical spring 17 and the bellows portion 5 as well as friction and other influences is not observed here, but it goes without saying that it would have to be taken into account in practice when designing the assembly device.

The assembly tool 19 is then moved to its starting position or removed. It must be ensured here that the helical spring 17 does not tear off the protective device 3 from the fastening stub 12 when it is being relaxed. If, in practice, in one defined embodiment, the holding force on the fastening stub 12 alone is not sufficient for this purpose, the supporting disk-side end of the protective device 3 may optionally be held at a defined reduced distance from the brake unit housing 2 by way of a suitable means, for example an external stop. The holding must be maintained until the actuating member 4 is mounted and fixed in the brake unit 1.

In another embodiment (not shown), the support means 9 can be dimensioned, for example by a defined design of the height of the axial projections, specifically such that a separate assembly tool 19 can be dispensed with and the protective device 3 is mounted directly by the actuating member 4. The assembly force F is introduced here from the actuating member 4 into the supporting disk 18, for example, during its first operation.

The protective device 3 together with the supporting disk 18, the helical spring 17 and the actuating member 4 can be provided as a pre-assembled composite, which is then finally assembled in a fully automated manner in a single assembly step by a simple linear pushing movement in the direction of the brake unit housing 2. At the same time, the actuating member 4 is latched in the piston and the protective device 3 is latched on the fastening stub 12. For this purpose, the helical spring 17 and the actuating member 4 must be fixed to the supporting disk 18. This can be achieved, for example, by using common fixing means such as a latching connection, spring rings, snap rings and the like.

FIG. 6 shows an enlarged representation of the fastening portion 11 of the protective device 3, which, during assembly, promotes self-centering and self-latching on the fastening stub 12 of the brake unit housing 2 and thus simplifies the automation capability of the assembly operation.

The axial fixing is carried out by an undercut 13. To form the undercut 13, a radial projection 15 formed on the fastening portion 11 is introduced into a circumferential radial depression 14 formed on the fastening stub 12. The radial projection 15 can be designed both as a kind of circumferential collar and in the form of several latching teeth which are spaced apart in the circumferential direction from each other. An inverted design of the undercut 13, with the radial projection on the fastening stub 12 and the radial depression on the fastening portion 11, remains also permissible.

The fastening portion 11 is elastic in the radial direction and formed with a smaller diameter than the fastening stub 12, whereby it is pushed in the axial direction by the action of the axially directed assembly force F with radial expansion over the fastening stub 12 and is simultaneously clamped radially until the radial projection 15 latches in the radial depression 14. Here, the built-up radial clamping force supports the adhesion of the protective device 3 to the fastening stub 12 both in the axial and in the circumferential direction, and thus also serves as a kind of anti-rotation safeguard.

For improved self-centering and improved sliding of the protective device 3 during assembly, the fastening stub 12 tapers at its radial outer edge and forms a mounting cone 20 there.

The fastening portion 11 is of funnel-shaped design for the same purpose in the direction of the brake unit housing 2 and thus forms a run-up slope.

The axial length of the fastening portion 11 may be designed greater than a maximum winding distance of the helical spring 17. This ensures that the protective device 3 slides reliably on the helical spring 17 during assembly and does not get caught between individual windings.

FIG. 7 shows a region of the fastening portion 11 of the embodiment according to the above description in a three-dimensional exterior view. Several reinforcing ribs 16, arranged spaced apart in the circumferential direction from each other, are formed on the radial outer circumference of the fastening portion 11.

These increase the axial stiffness of the fastening portion 11 while maintaining a low radial stiffness that is easy to install and ensure that the fastening portion 11 does not compress axially when mounted when pushed onto the fastening stub 12, thereby preventing the protective device 3 from being properly fixed to the brake unit housing 2.

When using lubricants for improving sliding properties in the contact area between the fastening portion 11 and the fastening stub 12, it would also be conceivable to dispense with the reinforcing ribs 16.

1. A brake unit for a motor vehicle brake system, comprising:
at least one brake unit housing;
at least one protective device fastened to the brake unit housing,
which is elastic and arranged as a barrier against dirt;
at least one axially compressible bellows portion of the at least one protective device with a plurality of outer folds and inner folds connected by flanks and alternately arranged in the axial direction; and
at least one integrated support of the at least one protective device for the defined reduction of an axial compression dimension of the bellows region.

2. The brake unit as claimed in claim 1, wherein the support comprises at least one axial projection arranged on the flank.

3. The brake unit as claimed in claim 2, wherein the support comprises at least two axial projections which are positioned so as to lie opposite one another and are arranged on respective sides of adjacent flanks and directed toward one another.

4. The brake unit as claimed in claim 2, wherein a plurality of axial projections which are positioned spaced apart from one another in the circumferential direction are arranged on the flank/

5. The brake unit as claimed in claim 2, wherein the at least one axial projection is formed as a bead which runs in the circumferential direction.

6. The brake unit as claimed in claim 1, wherein the support is arranged on an inner side of the bellows portion.

7. The brake unit as claimed in claim 1, wherein the protective device has a fastening portion on an end facing the brake unit housing, wherein the fastening portion is configured for arranging on a corresponding fastening stub of the brake unit housing with the formation of an axial undercut.

8. The brake unit as claimed in claim 7, wherein the undercut is formed by at least one radial projection which engages into a circumferential radial depression.

9. The brake unit as claimed in claim 7, wherein the fastening portion widens in a funnel-shaped manner in the direction of the brake unit housing for forming a run-up slope.

10. The brake unit as claimed in claim 7, wherein the fastening portion has a plurality of reinforcing ribs on a radial outer circumference and arranged spaced apart from one another in the circumferential direction.

11. The brake unit as claimed in claim 7, further comprising an axially oriented helical spring arranged radially within the protective device and the axial length of the fastening portion is of greater configuration than a maximum winding spacing of the helical spring.

12. The brake unit as claimed in claim 1, further comprising:
a separate supporting disk arranged at an end of the at least one protective device opposite the brake unit housing:
an actuating member on the supporting disk for actuating the brake unit supported axially in the direction of the brake unit housing; and
a helical spring clamped between the brake unit housing and the supporting disk.

13. The brake unit as claimed in claim 1, wherein at least one of outer folds and inner folds are formed as round folds with a constant or variable radius.

14. A method for mounting a protective device on a brake unit housing comprising:
attaching the protective device to a corresponding interface of the brake unit housing, and,
applying a defined axially directed assembly force applied to the end of the protective device opposite to the brake unit housing, and by this moving the protective device by a defined length in the direction of the brake unit housing to assemble the protective device.

15. The method as claimed in claim 14, further comprising introducing the assembly force into the protective device from an actuating member of the brake unit.

16. The method as claimed in claim 14, further comprising introducing the assembly force from a separate assembly tool.

17. The method as claimed in claim 16, wherein the assembly force into the protective device from the assembly tool is introduced into a supporting disk of a brake unit.

18. The method as claimed in claim 17, further comprising engaging the assembly tool into an opening of the supporting disk, which is configured for penetration with an actuating member during operation of the brake unit.
